(19) United States
(12) Patent Application Publication
(10) Pub. No.: US 2019/0002243 A1
(43) Pub. Date: Jan. 3, 2019

(54) ELEVATOR GUIDE RAIL CLEANER

(71) Applicant: Otis Elevator company, Farmington, CT (US)

(72) Inventors: Frédéric Beauchaud, Coullons (FR); Emmanuel Convard, La Bussiere (FR); Christele Gressien, La Bussiere (FR)

(21) Appl. No.: 16/064,542

(22) PCT Filed: Dec. 21, 2015
(86) PCT No.: PCT/IB2015/002601

§ 371 Date: Jun. 21, 2018

(51) Int. Cl. B66B 7/12; B66B 5/22; B66B 11/02

(52) U.S. Cl. CPC B66B 7/1292; B66B 11/024; B66B 5/22

(57) ABSTRACT

An elevator guide rail cleaning system is provided having at least one cleaning member configured to move from a first position to a second position, the cleaning member having a cleaning surface, wherein, in the first position, the cleaning surface is configured to not be in contact with a guide rail, and in the second position, the cleaning surface is in contact with the guide rail.

### BACKGROUND

The subject matter disclosed herein generally relates to elevator guide rails and, more particularly, to methods and apparatus for cleaning elevator guide rails after a safety block operation.

Some machines, such as elevator systems, include safety systems to stop the machine when it rotates at excessive speeds or, in the case of elevator systems, an elevator car travels at excessive speeds in response to an inoperative component. Conventional safety systems include an actively applied safety system that requires power to positively actuate the safety mechanism or a passively applied safety system that requires power to maintain the safety system in a hold operating state. Although passively applied safety systems offer an increase in functionality, such systems typically require a significant amount of power in order to maintain the safety system in a hold operating state, thereby greatly increasing energy requirements and operating costs of the machine. Further, passively applied safety systems typically feature larger components due to the large power requirements during operation, which may adversely affect the overall size, weight, and efficiency of the machine.

Further, some conventional systems are configured to engage with a guide rail of the elevator system, such that actuation and braking may be applied to stop an elevator car. Such configurations may be designed to operate specifically with the characteristics of the guide rail, such as be configured to operate effectively with the construction and material of the guide rail (e.g., machined, cold drawn, lubricated, oiled, etc.). After a stopping operation, the guide rail may be marked or have tracks formed thereon from a brake pad or other device that is used for engaging with a surface of the guide rail. The tracks or other marks must be cleaned or cleared and removed to ensure good ride quality after the stopping event.

### SUMMARY

According to one embodiment, an elevator guide rail cleaning system is provided. The system includes at least one cleaning member configured to move from a first position to a second position, the cleaning member having a cleaning surface, wherein, in the first position, the cleaning surface is configured to not be in contact with a guide rail, and in the second position, the cleaning surface is in contact with the guide rail.

In addition to one or more of the features described above, or as an alternative, further embodiments of the system may include that the cleaning surface is an abrasive surface of the cleaning member.

In addition to one or more of the features described above, or as an alternative, further embodiments of the system may include that the cleaning surface is a removably attachable surface that attaches to the at least one cleaning member.

In addition to one or more of the features described above, or as an alternative, further embodiments of the system may include that the at least one cleaning member is configured to at least one of rotate, translate, or slide from the first position to the second position.

In addition to one or more of the features described above, or as an alternative, further embodiments of the system may include a controller configured to control the cleaning member to move from the first position to the second position and back.

In addition to one or more of the features described above, or as an alternative, further embodiments of the system may include an elevator car, wherein the at least one cleaning member is attached to the elevator car or at a location proximate to a safety block.

In addition to one or more of the features described above, or as an alternative, further embodiments of the system may include a safety block attached to the elevator car and moveable to contact the guide rail to perform an emergency stopping operation, wherein the at least one cleaning member is located proximate to the safety block.

In addition to one or more of the features described above, or as an alternative, further embodiments of the system may include that the at least one cleaning member is accessible from at least one of an interior of the elevator car, on top of the elevator car, or outside the elevator car.

In addition to one or more of the features described above, or as an alternative, further embodiments of the system may include that the at least one cleaning member is configured to be at least one of manually operated or automatically operated from an interior of the elevator car.

According to another embodiment, a method of cleaning a guide rail of an elevator shaft is provided. The method includes operating a cleaning device from a first position to a second position such that the cleaning device engages with the guide rail in the second position, the cleaning device attached to an elevator car within the elevator shaft, moving the elevator car within the elevator shaft, with the cleaning device engaged with the guide rail, wherein the cleaning device is configured to clean a surface of the guide rail when in the second position, and operating the cleaning device from the second position to the first position.

In addition to one or more of the features described above, or as an alternative, further embodiments of the method may include that the cleaning device includes at least one cleaning surface that is an abrasive surface of the cleaning device.

In addition to one or more of the features described above, or as an alternative, further embodiments of the method may include that the cleaning device includes at least one cleaning surface that is a removably attachable surface that attaches to the cleaning device.

In addition to one or more of the features described above, or as an alternative, further embodiments of the method may include that operating the cleaning device comprises at least one of rotating, translating, or sliding a portion of the cleaning device from the first position to the second position.

In addition to one or more of the features described above, or as an alternative, further embodiments of the method may include that operating the cleaning device comprises controlling the cleaning device with a controller.

In addition to one or more of the features described above, or as an alternative, further embodiments of the method may include performing a maintenance operation on the cleaning device from at least one of an interior of the elevator car, on top of the elevator car, or outside the elevator car.

Technical effects of embodiments of the present disclosure include a cleaning device configured to clean a guide rail of an elevator shaft after an emergency stopping operation. Further technical effects include enabling cleaning of a guide rail without requiring a technician or other person to enter an elevator shaft. Further technical effects include enabling operation of a cleaning device such that a guide rail may be cleaned automatically.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2A is a schematic illustration of an emergency braking system of an elevator system;

FIG. 2B is an enlarged schematic illustration of an emergency braking system of an elevator system;

FIG. 3A is a schematic illustration of an elevator guide rail cleaning device in accordance with an embodiment of the present disclosure in a first position;

FIG. 3B is a schematic illustration of the cleaning device of FIG. 3A in a second position;

FIG. 4 is a schematic illustration of an alternative configuration of a guide rail cleaning device in accordance with the present disclosure; and

FIG. 5 is a flow process for cleaning a guide rail of an elevator shaft in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

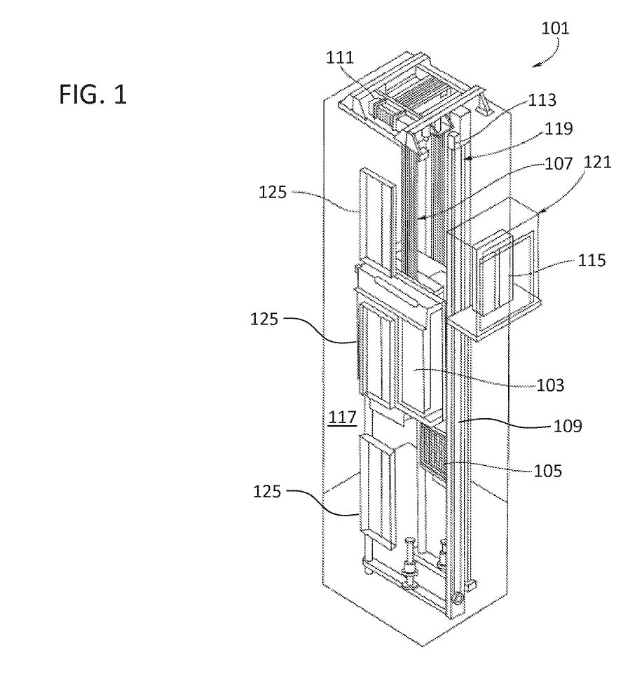

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

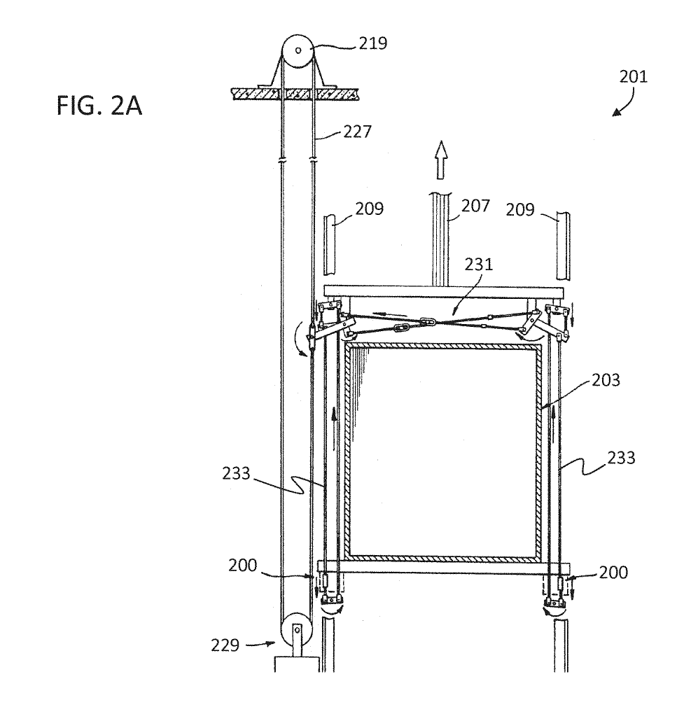

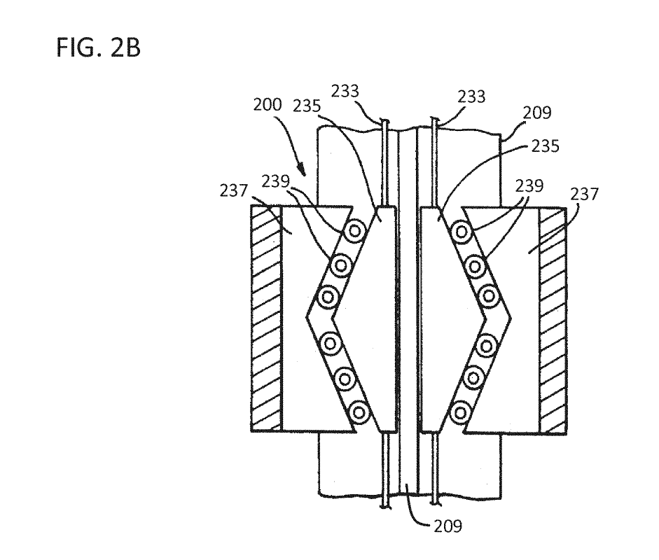

Referring to FIGS. 2A and 2B, an example of an elevator safety block 200, configured as a brake, will now be described. FIG. 2A shows an elevator system 201 employing the elevator safety block 200 and FIG. 2B shows as detailed view of the elevator safety block 200. The elevator system 201 includes an elevator car 203, guide rails 209 for guiding the elevator car 203 in upward and downward motion within an elevator shaft along guide rails 209, and roping 207 for raising and lowering the elevator car 203.

The safety mechanism for the elevator car 203 includes a governor 219, an endless governor rope 227, a tension adjuster 229 for the governor rope 227, elevator safety blocks 200 mounted on the elevator car 203 for stopping the elevator car 203 in the event of overspeeding, and a mechanical linkage 231 mounted on the elevator car 203 and connecting the governor rope 227 to the elevator safety blocks 200. The elevator safety blocks 200 are configured to releasably engage with the guide rails 209 to apply a braking force to the elevator car 203 in the event of an overspeed situation.

In operation, as the elevator car 203 starts to overspeed, either upward or downward, the governor rope 227 and governor 219 start to overspeed, thereby tripping the governor 219 which prevents further overspeeding of the governor rope 227. The governor rope 227 moves more slowly than the elevator car 203 thereby tripping the linkage 231. When the linkage 231 is tripped, the configuration pulls upward on actuators 233 which activate the elevator safety blocks 200. When the elevator safety blocks 200 are activated, the elevator safety blocks 200 will engage with the guide rails 209 and stop the elevator car 203.

Referring now to FIG. 2B, a detailed schematic of the elevator safety block 200 is shown. The elevator safety block 200 of FIG. 2 includes two parts, wedges 235 and wedge guides 237 that are configured about the guide rail 209. The wedge guides 237 are mounted in a fixed position relative to the elevator car 203. The wedges 235 are mounted so as to be movable vertically upwardly or downwardly relative to the elevator car 203 and are connected to the linkage 231 by the actuators 233.

During normal operation of the elevator car 203, that is to say when the elevator car 203 is travelling upwardly or downwardly at normal speed, the wedges 235 and wedge guides 237 are not in contact with the guide rail 209. However, if the elevator car 203 overspeeds thereby operating the linkage 231, the actuators 233 are caused to move upward relative to the elevator car 203. The upward motion of the actuators 233 forces the wedges 235 vertically upwardly relative to the wedge guides 237. A set of rollers 239 are provided between the wedge guides 237 and the wedges 235 to permit the relative movement. As the wedges 235 move up relative to the wedge guides 237, the wedges 235 also move horizontally toward the guide rail 209 as a result of the shape of the wedges 235 and wedge guides 237, and engage the elevator car guide rail 209, so as to prevent further movement of the elevator car 203.

Although shown and described with respect to a specific configuration in FIGS. 2A and 2B, those of skill in the art will appreciate that other configurations and/or components and/or features may be possible. Thus, the configuration of FIGS. 2A and 2B are merely provided for illustrative and explanatory purposes. It will be appreciated by those of skill in the art that traditional elevator safety blocks, such as shown in FIG. 2B, incorporate two movable portions positioned on either side of the guide rail.

During operation of the safety block 200, the guide rail 209 may be marked and tracks formed thereon when parts of the safety block 200 engage with surfaces of the guide rail 209. The marks and tracks may be debris and/or other material or marks that are formed in and on the guide rail 209 from the interaction of the parts of the safety block and the material and surfaces of the guide rail 209. After a stopping operation, the marks or tracks should be removed to ensure a smooth movement of the elevator car along the guide rail 209.

Accordingly, in accordance with embodiments provided herein, devices and systems for automatic removal of the tracks or marks formed on guide rails are provided. In some embodiments, the devices and systems may be operated and/or engaged from inside the elevator car.

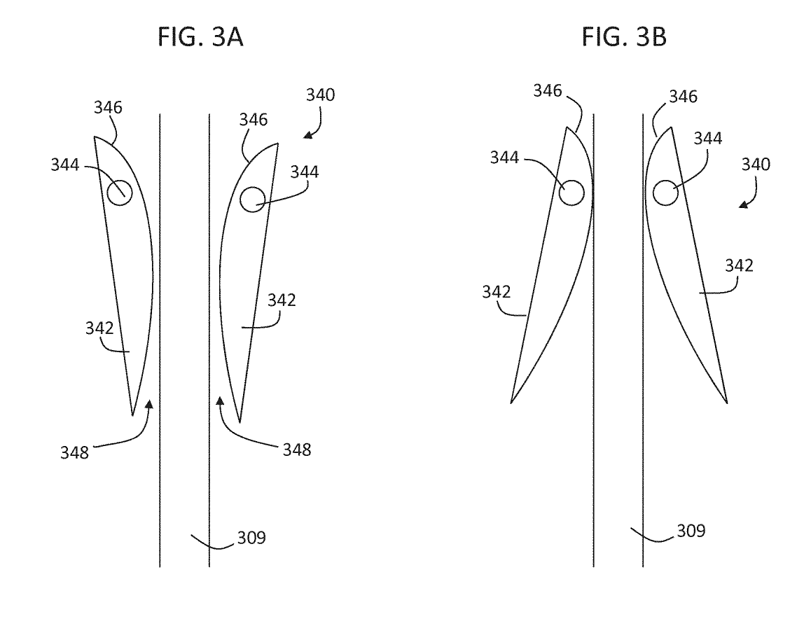

Turning now to FIGS. 3A and 3B, a schematic illustration of a cleaning device 340 is shown. FIG. 3A shows a schematic illustration of a cleaning device 340 in a first or disengaged position, wherein the cleaning device 340 is not in contact with a guide rail 309. FIG. 3B shows a schematic illustration of a cleaning device 340 in a second or engaged position, wherein the cleaning device 340 is in contact with the guide rail 309.

As shown in FIG. 3A, the cleaning device 340 may include cleaning members 342. The cleaning members 342 may be moveable from the first position to the second position. In the non-limiting embodiment of FIGS. 3A and 3B, the cleaning members 342 may be rotatable about pivots 344. In the engaged or second position of FIG. 3B, the cleaning members 342 are rotated such that a cleaning surface 346 of the cleaning members 342 is in contact with a surface of the guide rail 309. When in the first or disengaged position, the cleaning surfaces 346 are not in contact with the guide rail 309 and a clearance or gap 348 is formed between the cleaning surfaces 346 and the guide rail 309.

When the cleaning surfaces 346 are in contact with the guide rail 309, e.g., the second position shown in FIG. 3B, the cleaning surfaces 346 may be used to clean the guide rail 309. For example, the cleaning device 340 may be attached to an elevator car (not shown for simplicity) at a location close or proximate to a safety block. After the safety block is used, and tracks or other marks are made on the guide rail 309, the cleaning device 340 may be activated, controlled, and/or actuated from the first position to the second position. When in the second position, the cleaning device 340 may be moved up and down along the guide rail 309 such that the cleaning surfaces 346 may clean the guide rail 309. That is, in some embodiments, the cleaning device 340 is configured to clamp or catch the guide rail 309 between the cleaning members 342. In some embodiments, the cleaning may be performed or achieved by an abrasive surface or material of the cleaning members 342, i.e., the cleaning surfaces 346.

In some embodiments, with the cleaning members 342 engaged with the guide rail 309, the elevator car may be operated or controlled to move up and down, such as at inspection speeds as known in the art, to have the cleaning surfaces 346 clean the guide rail. The control and operation of the cleaning device 340 may be by automatic or manual operation. For example, in one non-limiting embodiment, a lever or other actuator may be located within the elevator car, and an operator may use the level or other actuator to move or control the cleaning device 340 from the first position (FIG. 3A) to the second position (FIG. 3B). The operator may then control the elevator car to move up and down within an elevator shaft, and the guide rail 309 may be cleaned. After the cleaning operation, the cleaning device may be actuated back to the first position (FIG. 3A), which forms the clearance 348. The clearance 348 allows the elevator car to move freely within the elevator shaft, and along the guide rail 309, and the cleaning device 340 does not impede the movement.

As will be appreciated by those of skill in the art, the cleaning device may be automatically controlled. For example, a computer controller may be configured to electrically or mechanically control the cleaning device 340 to move between the first position and the second position. In some embodiments, the controller may be a controller of the elevator car and/or the elevator system, and in other embodiments, the cleaning device 340 may have a dedicated or separate controller operationally configured therewith.

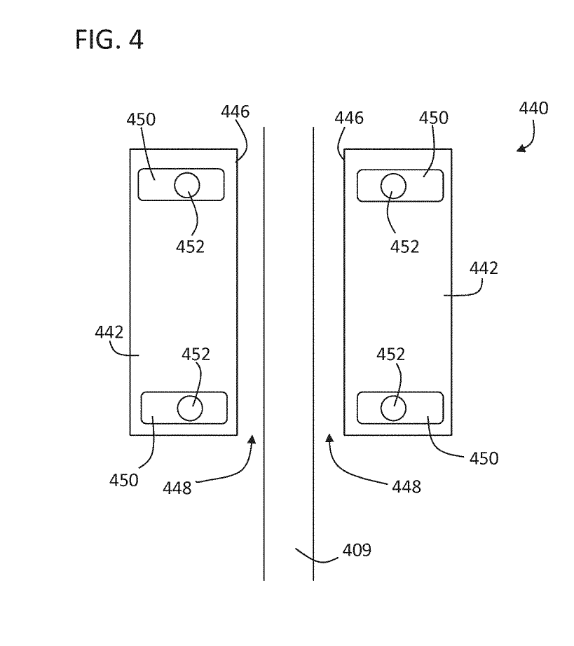

Turning now to FIG. 4, an alternative configuration of a cleaning device 440 in accordance with the present disclosure is shown. In the embodiment of the FIG. 4, the cleaning device 440 may be actuated or moved laterally or linearly with respect to a guide rail 409. As such, the cleaning device 440 includes cleaning members 442 that have cleaning surfaces 446 that are parallel with or to the guide rail 409. The cleaning members 442 may be configured to move laterally or translate along slots 450 (or other guides) with pins 452 (or other structures) that are configured to move within the slots 450. Further, as shown, the cleaning device 440 is in the first or disengaged position, with a clearance 448 shown. When the cleaning device 440 is moved into the second position, the cleaning surfaces 446 may engage with or contact surfaces of the guide rail 409 and may be used to clean the guide rail 409.

As shown, each cleaning member 442 includes two slots 450 with a respective pin 452 located therein. However, those of skill in the art will appreciate that any number and configuration of pins 452 and slots 450 may be used, and/or other configurations and means of movement may be used without departing from the scope of the present disclosure.

Although shown and described with two non-limiting embodiments, those of skill in the art will appreciate that other types and means of movement for engaging and disengaging the cleaning members of the cleaning device are contemplated by the present disclosure. As such, the cleaning members may be configured to rotate, translate, slide, or otherwise move from the first position to the second position and back.

The cleaning surfaces employed herein may be formed of abrasive texture or material that is configured to allow removal of tracks and debris from the guide rail without damaging the guide rail. In some embodiments, the cleaning surface may be a textured surface of the cleaning member itself. That is, in some embodiments, the cleaning surface may be formed of the same material as the cleaning members. In other embodiments, the cleaning surface may be removable from the cleaning member, and in some configuration may be a sheet or layer that is removably attachable to the cleaning members.

In some embodiments, the cleaning devices may be accessible from the interior of the elevator car such as through a panel or other access means. As such, maintenance, replacement, repair, and/or inspection of the cleaning devices may be performed from within the elevator car, without requiring a technician or other person to enter an elevator shaft to perform maintenance or other actions with respect to the cleaning devices. In some embodiments, the cleaning devices may be access from on top of the car and/or from outside the elevator.

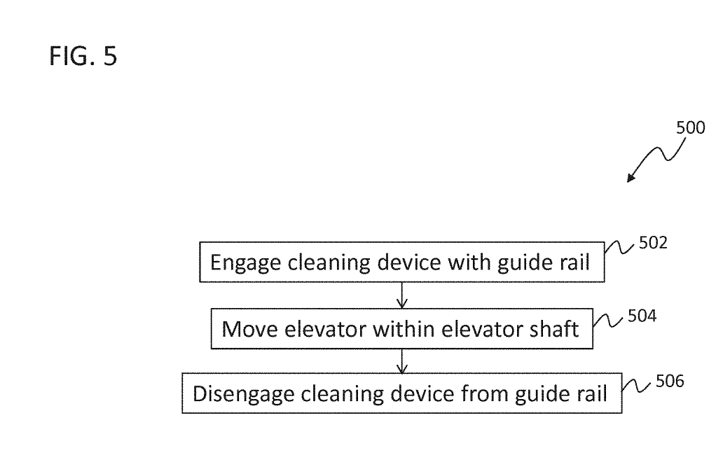

Turning now to FIG. 5, a flow process for cleaning an elevator guide rail after a safety block action in accordance with a non-limiting embodiment of the present disclosure is shown. The flow process may be performed by an elevator and/or elevator system configured with one or more cleaning devices, such as in one or more of the embodiments described above, although other configurations may employ flow process 500 without departing from the scope of the present disclosure. The flow process 500 may be performed after an emergency stopping operation of an elevator car where a safety block is used to engage with a guide rail and stop the elevator car from moving within an elevator shaft.

At block 502, a cleaning device is moved from a first position to a second positon so that the cleaning device is engaged with the guide rail. For example, after the emergency stopping, the cleaning device may be automatically or manually controlled to move from the first position to the second position, such that cleaning surfaces of the cleaning device engage with and contact the guide rail. The location of contact of the cleaning surfaces may be proximate or near the location of the safety block.

Control of the cleaning device may be manual or automated. For example, in some embodiments, a technician or other person may manually operate a level or other device such that the cleaning surfaces of the cleaning device engage with the guide rail. In other embodiments, the operation may be electronically controlled such that electrical or mechanical actuation of the cleaning device may be performed to move the cleaning surfaces into contact with the guide rail.

With the cleaning surfaces of the cleaning device engaged in the second position, the elevator may be moved within the elevator shaft, at block 504. That is, the elevator car may be operated such that the cleaning device moves along the guide rail. The cleaning surfaces of the cleaning device will remove debris and other marks or tracks on the guide rail over the distance of movement of the elevator car within the elevator shaft. That is, an abrading action may be performed by moving the elevator car within the elevator shaft up and down when the cleaning device is in a second or engaged position such that cleaning surfaces of the cleaning device are in contact with the guide rail.

After the cleaning is performed at block 504, the cleaning device may be disengaged from the guide rail, as shown at block 506. The disengagement or movement of the cleaning device from the second position to the first position may be performed manually or automatically, as described above.

As will be appreciated by those of skill in the art, although flow process 500 provides a particular order of steps, this is not intended to be limiting. For example, various steps may be performed in a different order and/or various steps may be performed simultaneously. For example, blocks 502-504 may occur substantially simultaneously such that the elevator car is moving within the elevator shaft as the cleaning device is controlled to engage with the guide rail, without departing from the scope of the present disclosure. Further, for example, blocks 504-506 may occur substantially simultaneously, in an opposite fashion, such that the cleaning device disengages from the guide rail while the elevator car is moving within the elevator shaft.

Advantageously, embodiments described herein provide a cleaning device for a guide rail of an elevator system that may provide effective guide rail cleaning after an operation of a safety block. Further, advantageously, embodiments provided herein may allow for maintenance operations from inside the car (i.e., there may be no need for an operator or technician to enter an elevator shaft). In some embodiments, maintenance may be performed from on top of the elevator car or from outside the elevator car. Further, embodiments provided herein enable a cleaning operation that may be safely carried out by a single mechanic in a very short time.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

For example, although shown with various structures and configurations for the cleaning device, those of skill in the art will appreciate that other geometries, configurations, means of movement, etc. may be used without departing from the scope of the present disclosure. Accordingly, the present disclosure is not to be seen as limited by the foregoing description, but is only limited by the scope of the appended claims.

1. An elevator guide rail cleaning system comprising:
at least one cleaning member configured to move from a first position to a second position, the cleaning member having a cleaning surface,
wherein, in the first position, the cleaning surface is configured to not be in contact with a guide rail, and
in the second position, the cleaning surface is in contact with the guide rail.

2. The system of claim 1, wherein the cleaning surface is an abrasive surface of the cleaning member.

3. The system of claim 1, wherein the cleaning surface is a removably attachable surface that attaches to the at least one cleaning member.

4. The system of claim 1, wherein the at least one cleaning member is configured to at least one of rotate, translate, or slide from the first position to the second position.

5. The system of claim 1, further comprising a controller configured to control the cleaning member to move from the first position to the second position and back.

6. The system of claim 1, further comprising an elevator car, wherein the at least one cleaning member is attached to the elevator car or at a location proximate to a safety block.

7. The system of claim 6, further comprising a safety block attached to the elevator car and moveable to contact the guide rail to perform an emergency stopping operation, wherein the at least one cleaning member is located proximate to the safety block.

8. The system of claim 6, wherein the at least one cleaning member is accessible from at least one of an interior of the elevator car, on top of the elevator car, or outside the elevator car.

9. The system of claim 6, wherein the at least one cleaning member is configured to be at least one of manually operated or automatically operated from an interior of the elevator car.

10. A method of cleaning a guide rail of an elevator shaft, the method comprising:
operating a cleaning device from a first position to a second position such that the cleaning device engages with the guide rail in the second position, the cleaning device attached to an elevator car within the elevator shaft;
moving the elevator car within the elevator shaft, with the cleaning device engaged with the guide rail, wherein the cleaning device is configured to clean a surface of the guide rail when in the second position; and
operating the cleaning device from the second position to the first position.

11. The method of claim 10, wherein the cleaning device includes at least one cleaning surface that is an abrasive surface of the cleaning device.

12. The method of claim 10, wherein the cleaning device includes at least one cleaning surface that is a removably attachable surface that attaches to the cleaning device.

13. The method of claim 10, wherein operating the cleaning device comprises at least one of rotating, translating, or sliding a portion of the cleaning device from the first position to the second position.

14. The method of claim 10, wherein operating the cleaning device comprises controlling the cleaning device with a controller.

15. The method of claim 10, further comprising performing a maintenance operation on the cleaning device from at least one of an interior of the elevator car, on top of the elevator car, or outside the elevator car.
